(19) United States
(12) Patent Application Publication
(10) Pub. No.: US 2007/0160134 A1
(43) Pub. Date: Jul. 12, 2007

(54) Methods and Systems for Filter Characterization

(76) Inventor: Christopher A. Segall, Camas, WA (US)

Correspondence Address: KRIEGER INTELLECTUAL PROPERTY, INC., P.O. BOX 1073, CAMAS, WA, 98607, US

(21) Appl. No.: 11/535,800

(22) Filed: Sep. 27, 2006

Related U.S. Application Data
(60) Provisional application No. 60/758,181, filed on Jan. 10, 2006.

(51) Int. Cl. H04B 1/66; H04N 11/02

(52) U.S. Cl. 375/240.1; 375/240.21

(57) ABSTRACT

Embodiments of the present invention comprise methods and systems for down-sampling and up-sampling an image. Some embodiments comprise methods and systems for sampling images for spatial scalability.

### RELATED REFERENCES

This application claims the benefit of U.S. Provisional Patent Application No. 60/758,181, entitled “Methods and Systems for Up-Sampling and Down-Sampling for Spatial Scalability,” filed Jan. 10, 2006, invented by Andrew Segall.

### FIELD OF THE INVENTION

Embodiments of the present invention comprise methods and systems for filter characterization and description. In some embodiments a characterized filter may be used for up-sampling for spatial scalability.

### BACKGROUND

H.264/MPEG-4 AVC [Joint Video Team of ITU-T VCEG and ISO/IEC MPEG, “Advanced Video Coding (AVC)—4th Edition,” ITU-T Rec. H.264 and ISO/IEC 14496-10 (MPEG4-Part 10), January 2005], which is incorporated by reference herein, is a video codec specification that uses macroblock prediction followed by residual coding to reduce temporal and spatial redundancy in a video sequence for compression efficiency. Spatial scalability refers to a functionality in which parts of a bitstream may be removed while maintaining rate-distortion performance at any supported spatial resolution. Single-layer H.264/MPEG-4 AVC does not support spatial scalability. Spatial scalability is supported by the Scalable Video Coding (SVC) extension of H.264/MPEG-4 AVC.

The SVC extension of H.264/MPEG-4 AVC [Working Document 1.0 (WD-1.0) (MPEG Doc. N6901) for the Joint Scalable Video Model (JSVM)], which is incorporated by reference herein, is a layered video codec in which the redundancy between spatial layers is exploited by inter-layer prediction mechanisms. Three inter-layer prediction techniques are included into the design of the SVC extension of H.264/MPEG-4 AVC: inter-layer motion prediction, inter-layer residual prediction, and inter-layer intra texture prediction.

### SUMMARY

Embodiments of the present invention comprise methods and systems for characterizing a filter and efficiently transmitting a filter design or selection to a decoder. In some embodiments, a filter is constructed based on the filter characterization and utilized to filter an image. In some embodiments, an up-sampling filter may be designed or selected at the encoder based on the down-sampling filter used, image characteristics, error or distortion rates and other factors. In some embodiments, the up-sampling filter may be represented by a combination of pre-established filters that are modified by weighting factors. The up-sampling filter selection may be signaled to the decoder by transmission of the weighting factors.

### BRIEF DESCRIPTION OF THE DRAWINGS

FIG. 1 is a chart showing a process of spatially-scalable encoding;

FIG. 2 is a chart showing a process of an exemplary image processing system wherein a filter is described with weighting factors;

FIG. 3 is a chart showing an exemplary process wherein an up-sampling filter is described with weighting factors; and

FIG. 4 is a chart showing an exemplary process wherein a decoder constructs a filter based on transmitted filter weighting factors.

### DETAILED DESCRIPTION OF EXEMPLARY EMBODIMENTS

It will be readily understood that the components of the present invention, as generally described herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Embodiments of the present invention may be understood by reference to the following document, which is incorporated herein by reference: JULIEN REICHEL, HEIKO SCHWARZ AND MATHIAS WIEN, “SCALABLE VIDEO CODING—WORKING DRAFT 4”, JVT-Q201, NICE, FR, OCTOBER, 2005.

Embodiments of the present invention comprise systems and methods for up-sampling for spatial scalability. Some embodiments of the present invention address the relationship between the up-sampling and down-sampling operations for spatial scalability. These tools are collectively called resampling and are a primary tool for scalable coding. In the context of embodiments used with SVC, down-sampling is a non-normative process that generates a lower resolution image sequence from higher resolution data. In these embodiments, upsampling is a normative process for estimating the higher resolution sequence from decoded, lower resolution frames.

### Upsample Design

In some embodiments, the upsampling operator may be designed within an optimization framework. For example, the upsampling operator may be found by minimizing the l₂-norm between the upsampled representation of previously decoded data and an original image. In general, this is expressed as

$$arg {min}_{U} ‖ f ( x , y ) ** U ( x , y , {x}^{′} , {y}^{′} ) - g ( {x}^{′} , {y}^{′} ) ‖ ,$$

where f(x,y) is the decoded low-resolution image, g(x′,y′) is the original high-resolution image and U(x,y,x′,y′) is the upsampling procedure that estimates g(x′,y′) from f(x,y). For notational convenience, this is also written in matrix-vector form as

$$arg {min}_{U} {‖ Uf - g ‖}^{2} , \qquad ( 1 )$$

where f is M×1 matrix that contains the low-resolution frame, g is the N×1 matrix that contains the original high-resolution image and U is the N×M matrix that denotes the upsampler. Note that both f and g are stored in lexicographical order.

Solving Eq. (1) results in the well known Wiener filter, which is expressed for the upsampling problem as

U=R_{gg}H^{T}(HR_{gg}H^{T}+Rₙₙ)⁻¹,

where H is the down-sampling operation and R_{gg} and Rₙₙ are respectively the correlation matrices for the original high-resolution frame and the noise introduced by coding the low-resolution frame. Notice that the filter depends on the statistics of the source frame and coding noise as well as the construction of the down-sampling operator.

Since we are interested in separable filters that are linear time/space invariant, we may choose to utilize a recursive least-squares algorithm (RLS) to solve Eq. (1). This allows enforcement of additional constraints during the optimization. The RLS algorithm recursively updates the following equations at each pixel in the high-resolution frame:

Pᵢ=(sᵢ^{T}Pᵢ₋₁sᵢ)⁻¹(Pᵢ₋₁−Pᵢ₋₁sᵢsᵢ^{T}Pᵢ₋₁) (2)

u₁=uᵢ₋₁Pᵢsᵢ(g[i]−uₜ₋₁^{T}sᵢ) (3)

where i is the pixel position in the lexicographically ordered high-resolution sequence, sᵢ is a vector containing the pixels in the low-resolution frame utilized for predicting the i-th pixel in the high-resolution frame, uᵢ is the current estimate of the upsampling filter, g[i] is the value of the pixel at location i and Pᵢ is a matrix.

In some embodiments, the upsampling operator is determined by minimizing an alternative norm formulation. For example, the Huber norm may be utilized.

### Down-Sample Family

In some embodiments, the optimal upsampling operator for a collection of down-sampling operators may be estimated or determined. These upsampling operators may either be computed off-line and stored prior to encoding image data or computed as part of the encoding process.

In some embodiments, estimating the up-sampling operation begins by computing QCIF versions for eight (8) sequences. Specifically, the Bus, City, Crew, Football, Foreman, Harbour, Mobile and Soccer sequences are considered. The QCIF representations are derived from original CIF sequences utilizing the different members of the filter family. The QCIF sequences are then compressed with JSVM 3.0 utilizing an intra-period of one and a Qp value in the set {20, 25, 30, 25}. This ensures that all blocks in the sequences are eligible for the IntraBL mode and provides sufficient data for the training algorithm. The decoded QCIF frames and original CIF frames then serve as input to the filter estimation procedure.

The RLS method in (2) and (3) estimates the filter by incorporating every third frame of the sequence. For the following results, the RLS algorithm processes the image sequence twice. The first iteration is initialized with P₀=10⁻⁶·I, where I is the identity matrix. Additionally, The elements in vector u₀ are defined to be zero, with the exception that u₀[2]=1. The second iteration re-initializes P₀=10⁻⁶·I, but the elements of u₀ are unchanged from the end of the first iteration. Additional iterations apply a weighting matrix to achieve a mixed-norm solution.

Filters for the different down-sample configurations are then compared to the current method of upsampling. In some embodiments, the tap values for the interpolating AVC six-tap filter are subtracted from the estimated upsampling coefficients and the residual is processed with a singular value decomposition algorithm. The correction tap values are decomposed as follows:

TABLE 3

| | | | | | | | | | | | |
|---|---|---|---|---|---|---|---|---|---|---|---|
| 4 | 1 | −10 | −12 | 7 | 20 | 7 | −12 | −10 | 1 | 4 | 0 |
| −1 | −11 | −8 | 11 | 10 | 1 | 10 | 11 | −8 | −16 | −1 | 5 |
| −13 | −11 | 11 | 0 | 2 | 16 | 2 | 0 | 11 | 0 | −13 | −6 |
| −2 | −6 | −7 | 4 | 9 | −7 | 9 | 4 | −7 | 20 | −2 | −15 |
| 10 | −23 | −1 | 2 | −9 | 6 | −9 | 2 | −1 | 7 | 10 | 5 |
| 7 | 8 | −1 | 7 | −6 | 10 | −6 | 7 | −1 | −9 | 7 | −23 |
| −11 | −8 | −10 | −8 | −10 | −8 | −10 | −8 | −10 | −8 | −11 | −8 |

with singular values [33.75, 11.32, 3.56, 1.81, 0.81, 0.49, 0.02].

### Exemplary Embodiments

In some embodiments, one may incorporate correction information for the upsampler into the sequence parameter set and slice level header. The bit-fields contain the scale factors that should be applied to the first two sets of correction tap values. Specifically, the upsample correction bit-field may contains two parameters, s1 and s2, that control the upsample filter according to

Upsample Filter=F1+s1*F2+s2*F3

where F1, F2 and F3 are

F1=[1 0 −5 0 20 32 20 0 −5 0 1 0]/32

F2=[4 1 −10 −12 7 20 7 −12 −10 1 4 0]/32

F3=[−1 −11 −8 11 10 1 10 11 −8 −16 −1 5]/32

The scale values are transmitted with fixed point precision and may vary on a slice-by-slice granularity. Scale values are optionally transmitted for each phase of the filter. Additional scale values may optionally be transmitted for the chroma components. The filter tap values in F1, F2 and F3 may differ for the chroma channels. Also, the filter tap values for F1, F2 and F3 may differ for different coding modes. For example, inter-predicted blocks may utilize a different upsampling filter than intra-coded blocks. As a second example, filter coefficients may also identify the filter utilized for smoothed reference prediction. In this case, a block is first predicted by motion compensation and then filtered. The filtering operation is controlled by the transmitted scale values. The residual is then up-sampled from the base layer utilizing a second filter that is controlled by the bit-stream. This second filter may employ the same scale factors as the smoothed reference filtering operation or different scale factors. It may also utilize the same tap values for F1, F2 and F3 or different tap values.

In some exemplary embodiments, three sets of tap values, F1, F2 and F3, are utilized. This is for example only, as some embodiments may employ more or less than these three sets. These embodiments would comprise a correspondingly different number of scale factors.

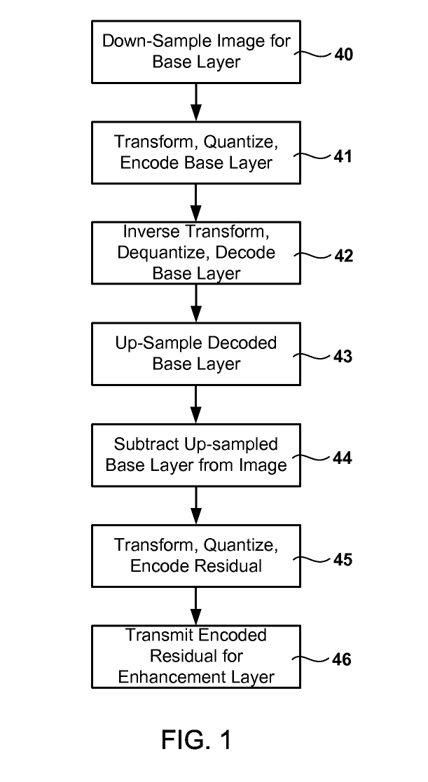

Some embodiments of the present invention may be described with reference to FIG. 1. These embodiments may be used in conjunction with a spatially scalable image codec. In these embodiments, an image is down-sampled 40 to create a base layer. The base layer may then be transformed, quantized and encoded 41 or otherwise processed for transmission or storage. This base layer may then be inverse transformed, de-quantized and decoded 42 as would be performed at a decoder. The decoded base layer may also be up-sampled 43 to create an enhancement layer or higher-resolution layer. This up-sampled image may then be subtracted 44 or otherwise compared with the original image to create a residual image. This residual image may then be transformed, quantized and encoded 45 as an enhancement layer for the image. The encoded enhancement layer may then be transmitted 46 or stored for decoding in a spatially scalable format.

For encoding efficiency and image quality, the up-sampling filter is matched to the down-sampling filter to minimize errors and artifacts. However, when differing down-sampling filters may be used and a variety of image characteristics must be accommodated, it is useful to design an up-sampling filter that perform well with a specific down-sampler and/or a specific image type. Accordingly, a variable up-sampling filter or a family of up-sampling filters that may be selected and/or varied may increase system performance.

Some embodiments of the present invention comprise a plurality of up-sampling filter definitions that may be stored on an image encoder and decoder combination. Since the filters are defined at both the encoder and decoder, a selection of combination of the filters may be described by signaling a weighting factor for each filter. This format allows a filter selection to be transmitted with simple weighting factors and without the transmission of an entire filter description of full range of filter coefficients.

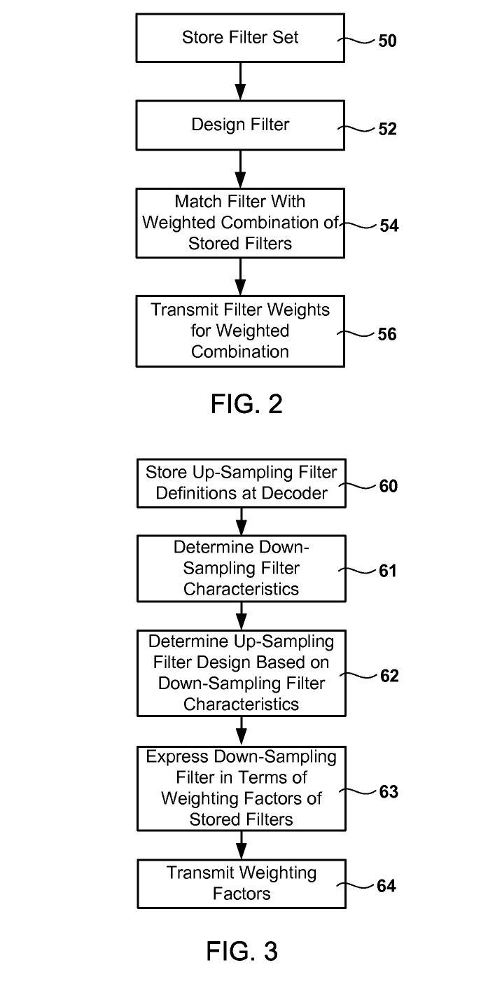

Some embodiments of the present invention may be described with reference to FIG. 2. In these embodiments, a plurality of filter definitions are stored 50 at an encoder while the same definitions are known at the decoder. A filter is then designed 52. Filter design may be affected by the image characteristics, down-sampling filter characteristics, characteristics of a reconstructed base layer, error or distortion parameters or other criteria. Once a filter is designed, filter may be represented with a weighted combination of the stored filters 54. This combination may be expressed as a series of weighting factors that relate to the stored filter definitions. These weighting factors may then be transmitted 56 to a decoder to indicate the appropriate filter to be used in the decoding process.

Some embodiments of the present invention may be described with reference to FIG. 3. In these embodiments, a plurality of up-sampling filter definitions may be stored on a decoder 60 while the same filter definitions are known at a corresponding encoder. The characteristics of a down-sampling filter used to down-sample a subject image are then determined 61. Based, at least in part, on these down-sampling filter characteristics, an up-sampling filter may be designed 62. Image characteristic and other factors may also affect the down-sampling filter design. Once this down-sampling filter is designed or selected, the filter may be described as one or more weighting factors 63 corresponding to the stored filter definitions. These weighting factors may then be transmitted 64 to a decoder for up-sampling of the image.

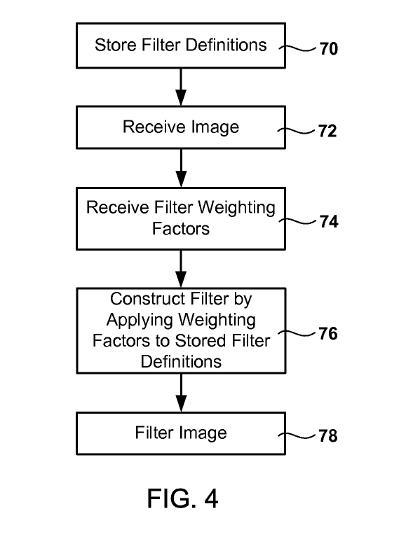

Some embodiments of the present invention may be described with reference to FIG. 4. In these embodiments, a plurality of filter definitions are stored at a decoder 70 while the filters described by these definitions are also known to a corresponding encoder. When an image is received 72 at the decoder, an associated set of filter weighting factors is also received 74. The weighting factors may be encoded in the image itself of may be signaled separately. By applying the weighting factors to the stored filter definitions, a customized filter may be constructed 76. This filter may then be used to filter the image 78, such as in an up-sampling process.

The terms and expressions which have been employed in the forgoing specification are used therein as terms of description and not of limitation, and there is no intention in the use of such terms and expressions of excluding equivalence of the features shown and described or portions thereof, it being recognized that the scope of the invention is defined and limited only by the claims which follow.

I claim:

1. A method for signaling a filter selection from an encoder to a decoder, said method comprising:
a) storing a plurality of filter definitions at an encoder and a decoder;
b) determining filter characteristics for a sampling task;
c) selecting a weighted combination of filters defined in said filter definitions, wherein said weighted combination meets said filter characteristics; and
d) transmitting filter weighting factors from said encoder to said decoder, wherein said weighting factors communicate said weighted combination.

2. A method as described in claim 1 wherein said filter definitions comprise tap values for a family of filters.

3. A method as described in claim 1 wherein said determining filter characteristics comprises analysis of input image characteristics.

4. A method as described in claim 1 wherein said sampling task comprises up-sampling and said determining filter characteristics comprises analysis of the down-sampling process and down-sampling filter data.

5. A method as described in claim 1 wherein said determining filter characteristics comprises a rate/distortion analysis.

6. A method as described in claim 1 wherein said filtering task comprises re-sampling and said determining filter characteristics comprises analysis of a reconstructed base layer image.

7. A method as described in claim 1 wherein said selecting a weighted combination of filters comprises evaluation of error rates for various combinations of weighting factors.

8. A method for selecting and signaling an up-sampling filter selection from an encoder to a decoder, said method comprising:
a) storing a plurality of up-sampling filter definitions at an encoder and a decoder;
b) determining down-sampling filter characteristics;
c) selecting a weighted combination of filters that are defined in said filter definitions, wherein said weighted combination defines an up-sampling filter; and
d) transmitting filter weighting factors from said encoder to said decoder, wherein said weighting factors communicate said weighted combination.

9. A method as described in claim 8 wherein said plurality of up-sampling filter definitions comprise definitions for filters with varying quantities of tap values.

10. A method as described in claim 8 wherein said up-sampling filter definitions comprise definitions for filters with multiple phases.

11. A method for filtering an image at a decoder, said method comprising:
a) storing a plurality of filter definitions at a decoder;
b) receiving an image;
c) receiving filter weighting factors at said decoder, wherein said weighting factors communicate a weighted combination of filters defined in said filter definitions; and
d) filtering said image using said weighted combination of filters.

12. A method as described in claim 11 wherein said plurality of filter definitions comprise definitions for filters with varying quantities of tap values.

13. A method as described in claim 11 wherein said filter definitions comprise definitions for filters with multiple phases.

14. A method as described in claim 11 wherein said filter definitions comprise tap values for a family of filters.

15. A method as described in claim 11 wherein said weighting factors have been determined using methods comprising image analysis of said image.

16. A method as described in claim 11 wherein said weighting factors have been determined using methods comprising analysis of the down-sampling operator and down-sampling filter data.

17. A method as described in claim 11 wherein said weighting factors have been determined using methods comprising a rate/distortion analysis.

18. A method as described in claim 11 wherein said weighting factors have been determined using methods comprising analysis of a reconstructed base layer frame.

19. A method as described in claim 11 wherein said weighting factors have been determined using methods comprising evaluation of error rates for various combinations of weighting factors.

20. A method as described in claim 11 wherein said image is a base layer image that has been down-sampled from a higher resolution image and said weighting factors have been determined using methods comprising analysis of a down-sampling filter used to create said base layer.
